(19) United States
(12) Patent Application Publication
(10) Pub. No.: US 2017/0009354 A1
(43) Pub. Date: Jan. 12, 2017

(54) METHOD AND COMPOSITION FOR REDUCING SILICA BASED EVAPORATOR SCALING

(71) Applicant: CARGILL, INCORPORATED, Wayzata, MN (US)

(72) Inventors: Brent A. Hawkins, Eurenka, CA (US); Manoj SAHOO, Plymouth, MN (US)

(21) Appl. No.: 15/115,840

(22) PCT Filed: Jan. 27, 2015
(86) PCT No.: PCT/US15/13018

§ 371 Date: Aug. 1, 2016

Related U.S. Application Data
(60) Provisional application No. 61/933,999, filed on Jan. 31, 2014.

(51) Int. Cl. C23F 14/02; D21C 3/22; D21C 11/00; C02F 1/52

(52) U.S. Cl. CPC C23F 14/02; C02F 1/5236; D21C 3/22; D21C 11/00; C02F 2101/10

(57) ABSTRACT

Some embodiments of the present invention relate to a method for reducing the concentration of reactive silica in a first composition comprising adding a first amount of a calcium salt and a second amount of a magnesium salt to the first composition to form a solid silicate composition comprising one or more silicates, wherein the first composition comprises an aqueous solution; and a significant portion of the reactive silica in the first composition is converted to one or more silicate in the solid silicate composition.

### CROSS-REFERENCE TO RELATED APPLICATIONS

This application claims the benefit of the U.S. Patent Application Ser. No. 61/933,999 filed Jan. 31, 2014, entitled METHOD AND COMPOSITION FOR REDUCING SILICA BASED EVAPORATOR SCALING, which application is hereby incorporated by reference herein in its entirety.

### BACKGROUND

Silica based minerals are present to some degree in all fibrous raw materials used for making paper pulp. A portion of the silica is on the surface of the raw materials as soil particles and a portion is occluded within and among the plant cells. During the cooking process the minerals become fluid borne silicates. For the raw materials containing large amounts of silica, scaling of equipment for use in processing pulping compositions or compositions associated with pulping (e.g. black liquor) can be problematic since the silicates tend to form scale. For equipment having large surface areas such as heat exchangers (especially evaporator tubing and liquor heaters), silicate scaling is economically troublesome.

Without intention to be bound to a particular theory, not all types of silica can cause a scaling problem. The type of silica that may contribute the most to the scaling problem is known as reactive silica or colloidal silica. The reactive silica is soluble in solution and may react with hot surfaces and other silica particles. In North America, where the reactive silica is present in very small amounts, evaporators typically may operate for six months to a year between cleaning. While in India where the reactive silica exists in more significant amounts, the evaporators may operate only a few days without cleaning. Thus, there is a need to reduce the amount of scaling in further processes of the pulping composition or compositions associated with pulping (e.g. black liquor), and to extend the cleaning interval of the corresponding equipment.

### DETAILED DESCRIPTION

Features and advantages of the present invention will become apparent from the following detailed description. It should be understood, however, that the detailed description and the specific examples, while indicating the preferred embodiments of the present invention, are given by way of illustration only, since various changes and modifications within the spirit and scope of the present invention will become apparent to those skilled in the art from this detailed description.

One aspect of the invention relates to a method for reducing the concentration of reactive silica in a first composition comprising adding a first amount of a calcium salt and a second amount of a magnesium salt to the first composition to form a solid silicate composition comprising one or more silicates, wherein:
the first composition comprises an aqueous solution; and
a significant portion of the reactive silica in the first composition is converted to one or more silicate in the solid silicate composition.

As used herein, “a significant portion” of a component in composition is at least about 25% of the total amount of the component in the composition, at least about 35% of the total amount of the component in the composition, at least about 45% of the total amount of the component in the composition, at least about 50% of the total amount of the component in the composition, at least about 75% of the total amount of the component in the composition, at least about 90% of the total amount of the component in the composition, at least about 95% of the total amount of the component in the composition, at least about 98% of the total amount of the component in the composition, or at least about 99% of the total amount of the component in the composition.

In certain embodiments, the calcium salt is a soluble calcium salt, e.g. calcium acetate, calcium nitrate, calcium chloride, calcium chlorate, calcium bromide, calcium bromate, and calcium iodide. In certain embodiments, the magnesium salt is a soluble magnesium salt, e.g. magnesium acetate, magnesium bromide, magnesium chlorate, magnesium chloride, magnesium iodide, magnesium sulfate, and magnesium thiosulfate.

In certain embodiments, the molar ratio of the first amount to the second amount is 1:1, which is the stoichiometric ratios of calcium ion and magnesium ion in the mineral diopside, MgCaSi₂O₆. In certain embodiments, the first amount and the second amount are small such that the added calcium salt and the added magnesium salt will not cause significant scaling in later processes.

MgCaSi₂O₆ is insoluble in aqueous solutions. In certain embodiments, the diopside crystals act as seed crystals. Once established, silicate will continue to precipitate from the diopside crystals, and deplete the concentration of reactive silicates in the composition to be treated and reduce scaling in equipment used in later processes (e.g., evaporators). In certain embodiments, the amounts of calcium salt and magnesium salt added to the composition to be treated are too small to cause a scaling problem by themselves. In certain embodiments, a significant portion of the calcium ions and magnesium ions added are precipitated as one or more silicates of the solid silicate composition (e.g., MgCaSi₂O₆).

In certain embodiments, the first composition is a pulping composition or a composition associated with pulping (e.g. black liquor), the seed crystals and silicates precipitated therefrom may follow the pulp or remain as unreactive silica in the liquor. Alternatively, the seed crystals and silicates precipitated therefrom can be cleaned from the pulp by any means (e.g., any conventional means) or can be left on the fiber.

By precipitating the reactive silica in the solution, the tendency of the solution to form scale in later processes (e.g., evaporation) is reduced because the reactive silicates are precipitated to unreactive silicates. Thus, the method disclosed herein can significantly reduce silica scaling of the first composition in later processes (e.g., evaporation) after treated with said method disclosed herein.

In certain embodiments, the method further comprises removing a significant portion of the solid silicate composition comprising one or more reactive silicates. The term “a significant portion” is defined the same as set forth supra. The method may also include determining the amount of reactive silicates in the composition to be treated to determine the proper amount of, e.g., calcium salt and magnesium salt to be added.

Another aspect of the invention relates to a composition or additive for performing the method disclosed herein. One skilled in the art will appreciate that the composition or additive can include a first amount of a calcium salt (e.g. calcium chloride) and a second amount of a magnesium salt (e.g. magnesium chloride) as set forth herein and sufficient to cause the formation of a solid silicate composition when added to a pulp composition or a composition associated to pulping (e.g. a black liquor) and thereby reduce or prevent equipment fouling due to scaling when processing such compositions.

In certain embodiments, the composition or additive can further comprise one or more chemicals for using in the pulping process such as anthraquinone (AQ). In other embodiments other additives may be included in the composition to aid in dispersion by providing a more uniform and better mixed solution that will react better with the calcium and magnesium ions. Such additives include one or more of surfactants (including anionic, cationic, carboxylates, nonionic, zwitterionic, fluorosurfactant, siloxane), biosurfactants, plasticizers, supeiplasticizers (e.g., polycarboxylate), defloculatants, polymeric dispersants, polyacrylates, polymethacrylate.

### EXAMPLES

### Example 1

CaCl₂ and MgCl₂ can be added to a black liquor, wherein the molar ratio of CaCl₂:MgCl₂ is 1:1, and a solid silicate composition can be formed from the black liquor. At least 50% of the reactive silica in the black liquor can be removed from the black liquor when it is converted to one or more silicates of the solid silicate composition. The black liquor treated with the method described herein will cause much less scaling compared to the black liquor not treated with the method. The time-interval between cleaning for equipment used in later processes of the black liquor is increased significantly, e.g., about a few days more.

Although the invention has been described with respect to specific embodiments and examples, it will be readily appreciated by those skilled in the art that modifications and adaptations of the invention are possible without deviation from the spirit and scope of the invention. Accordingly, the scope of the present invention is limited only by the following claims.

1. A method for reducing silica based scaling in a first composition to be treated comprising an aqueous solution, comprising adding a first amount of a soluble calcium salt and a second amount of a soluble magnesium salt to the first composition to form a solid composition comprising one or more silicates, wherein:
the first composition comprising an aqueous solution comprises a pulping composition or a composition associated with pulping; and
a significant portion of the reactive silica in the first composition is converted to one or more silicate in the solid composition.

2. The method according to claim 1, wherein the molar ratio of the first amount of the soluble calcium salt: the second amount of the soluble magnesium salt is 1:1.

3. The method according to claim 1, wherein at least one silicate of the solid composition is a mineral diopside, MgCaSi₂O₅.

4. The method according to claim 1, wherein the first composition is a black liquor.

5. The method according to claim 1, further comprising removing a significant portion of the solid composition.

6. The method according to claim 5, wherein the significant portion of a composition is at least about 50% of the total amount of the composition, at least about 75% of the total amount of the composition, at least about 90% of the total amount of the composition, at least about 95% of the total amount of the composition, at least about 98% of the total amount of the composition, or at least about 99% of the total amount of the composition.

7. The method according to claim 1, wherein the soluble calcium salt is selected from the group consisting of calcium acetate, calcium nitrate, calcium chloride, calcium chlorate, calcium bromide, calcium bromate, and calcium iodide.

8. The method according to claim 1, wherein the soluble magnesium salt is selected from the group consisting of magnesium acetate, magnesium bromide, magnesium chlorate, magnesium chloride, magnesium iodide, magnesium sulfate; and magnesium thiosulfate.

9. A composition or additive for performing the method according to claim 1, comprising a first amount of a soluble calcium salt and a second amount of a soluble magnesium salt.

10. The composition or additive according to claim 9, further comprising one or more chemicals selected from the group consisting of anthraquinone (AQ) and one or more dispersants.

11. The composition of claim 10 wherein the dispersant is selected from the group consisting of one or more surfactants or biosurfactants, plasticizers, superplasticizers, defloculatants, polymeric dispersants, polyacrylates, and polymethacrylate.

12. The composition of claim 11 wherein the surfactant is anionic, cationic, nonionic, zwitterionic, a fluorosurfactant, a carboxylate, and siloxane.
